(19) United States
(12) Patent Application Publication
(10) Pub. No.: US 2015/0102148 A1
(43) Pub. Date: Apr. 16, 2015

(54) DEVICE FOR PROCESSING FREE-FLOWING INPUT MATERIAL

(71) Applicant: PALLMANN MASCHINENFABRIK GmbH & Co. KG, Zweibruecken (DE)

(72) Inventor: Hartmut PALLMANN, Zweibruecken (DE)

(21) Appl. No.: 14/516,099

(22) Filed: Oct. 16, 2014

(30) Foreign Application Priority Data
Oct. 16, 2013 (DE) 10 2013 017 134.2

(51) Int. Cl. B02C 4/30; B30B 15/00; B30B 3/04; B02C 4/02; B30B 3/00

(52) U.S. Cl. CPC B02C 4/30; B02C 4/02; B30B 3/005; B30B 3/04; B30B 15/0005
USPC 241/227; 100/173; 425/471

(57) ABSTRACT

A device for processing free-flowing input material, having a machine frame formed by longitudinal and transverse walls, in which a rolling mill having at least one pair of oppositely rotating rollers is disposed axially parallel next to one another so as to maintain a radial roller gap and are rotatably mounted in the transverse walls. The input material is processed upon passage through the roller gap. The region located upstream of the roller gap is used to feed the input material, and the downstream region is used to discharge the material. In order to minimize the disruptions caused by wear and thermal load, it is provided that the upstream region for feeding comprises a feed chute having longitudinal chute walls and end chute walls, the end chute walls each disposed with axial separation between the transverse walls of the machine frame in order to form an open space.

This nonprovisional application claims priority under 35 U.S.C. §119(a) to German Patent Application No. 10 2013 017 134.2, which was filed in Germany on Oct. 16, 2013, and which is herein incorporated by reference.

### BACKGROUND OF THE INVENTION

1. Field of the Invention

The invention relates to a device for processing free-flowing input material.

2. Description of the Background Art

Such devices are found in the field of mechanical processing engineering. The basic principle of material processing results from the interaction of oppositely rotating rollers that form a narrow roller gap. In order to be processed, the free-flowing input material is exposed to high pressure and shear forces upon passage through the gap. The region located upstream of the roller gap is therefore used to feed the input material to the processing zone, and the downstream region is used to discharge the material out of the device after material processing has been carried out. The nature of the input material can be diverse, and extends from relatively hard materials, such as minerals, to soft input material in the form of chemicals, foodstuffs, rubber, plastic, and the like.

Roller mills are generally known which comprise a housing formed of longitudinal and transverse walls, in which said housing the rollers extend from one transverse wall to the opposite transverse wall, where they are rotatably mounted in bearings on the outer sides thereof. Suitable design measures are implemented to ensure that all of the input material, if possible, is fed to the roller gap without circumventing the processing zone.

For this purpose, the rollers in the mill disclosed in DE 197 15 210 A1 extend, via the shell surfaces thereof that are effective for material processing, to the transverse walls of the housing so as to maintain a sealing gap. The rollers, which move relative to the transverse walls during comminution, pick up the input material on the circular trajectory thereof, which results in friction on the fixed transverse walls. This results in considerable wear on the inner side of the transverse walls and heat being input into the transverse walls themselves, since a portion of the supplied drive energy is converted into frictional heat. This excessive heat energy is unwanted primarily in the region of the bearings of the rollers, and therefore additional measures may be required in order to cool these rollers, which increases the costs of the machine construction.

### SUMMARY OF THE INVENTION

It is therefore an object of the present invention to improve the devices in terms of the wear and thermal load thereof.

In an embodiment, it is provided to displace a connection region of rotating rollers at fixed machine parts axially inwardly in the direction toward a center of the housing. This is achieved according to the invention by means of a feed chute, which is not limited in the axial direction by the transverse walls of the machine housing, but rather by providing end chute walls, which are offset axially inwardly and thereby form an open space. The end chute walls are therefore disposed with axial separation between the transverse walls.

The open space between the housing transverse wall and the end chute wall eliminates the thermal problems described above. The open space functions as thermal insulation for the transverse wall, the thermal load of which is therefore reduced. Temperature-related problems therefore occur to a much less extent in a device according to the invention. In an advantageous development of this concept, cooling air can flow through the open space in order to cool the device, wherein this cooling air is supplied, for example, through openings in the housing, in particular in the transverse wall. When the flow takes place through the open space from top to bottom, the cooling air additionally supports the material flow. Due to the reduced thermal load, it is possible to dispose the bearings for the rollers on the transverse walls of the device without the risk of thermal overload, which results in a design that is not only considerably simplified but is also made more compact.

Moreover, material that enters the connection gap between the end chute walls and the rollers is fed back to the remaining material stream still inside the housing, directly and without any further measures. In order to support this, the open space in an advantageous development of the invention is closed at the sides and toward the top.

The invention also comprises embodiments in which the end chute walls radially overlap with the end faces of the rollers and thereby form a sealing gap and, in this manner, abut the rollers, with the advantage that the length of the rollers can be as short as possible and, therefore, the device can be designed to be particularly compact.

In an embodiment, the end chute walls bluntly adjoin the shell surface of the rollers in the radial direction so as to maintain a sealing gap, i.e., the rollers extend underneath the end chute walls. This makes it possible to dispose the roller ends in the region that is kept free of input material, thereby ensuring that this region is not exposed to the effects of the input material during the material processing. In embodiments, in particular, comprising rollers in which the shell segments are fastened only in the end region of the rollers, this situation is particularly effective since the fastening component remain unaffected in the protected region and are therefore easier to loosen in order to replace the shell segments.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a longitudinal view through a device according to the invention, along the line I-I shown in FIGS. 2 and 3,

FIG. 2 shows a cross-section through the device depicted in FIG. 1, along the line II-II therein,

FIG. 3 shows a cross-section through the device depicted in FIG. 1, along the line III-III therein,

FIG. 4 shows a view of the device depicted in FIG. 1 along the line IV-IV therein,

FIG. 5 shows a detail of the roller shell depicted in FIG. 2, and

FIG. 6 shows a detail of the roller shell depicted in FIG. 3.

### DETAILED DESCRIPTION

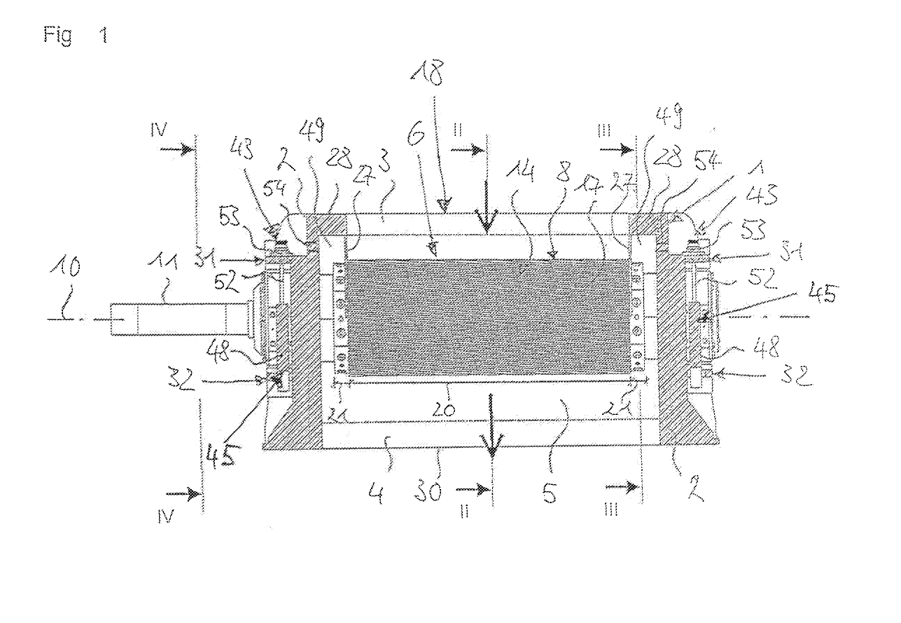

FIGS. 1 to 4 show the structural design of a device according to the invention. Shown therein is a machine main frame 1, which is substantially formed of plane parallel, oppositely disposed transverse walls 2, which are interconnected by means of laterally spaced apart, upper longitudinal beams 3 and, opposite thereto, outwardly offset, lower longitudinal beams 4. In order to form a housing, the longitudinal sides of the machine main frame 1 are covered with lateral coverings 5, which connect to the upper and lower longitudinal beams 3, 4. The lateral coverings 5 are removable, thereby ensuring access to the housing interior on each longitudinal side of the device between the upper longitudinal beam 3 and the lower longitudinal beam 4.

The machine main frame 1 accommodates a rolling mill 6, which, in the present embodiment, is formed of a roller pair having oppositely rotating rollers 7 and 8, which are located axially parallel next to one another, the axes of rotation of which are labelled with reference signs 9 and 10. An inner radial separation is maintained between the two rollers 7, 8 in order to form a roller gap, which functions as the processing zone. In order to ensure that the rollers 7, 8 are mounted so as to be rotatable, said rollers are guided via the shaft stubs 11 thereof through openings in the transverse walls 2, where said shaft stubs are retained in bearings outside the housing, which will be described in greater detail below.

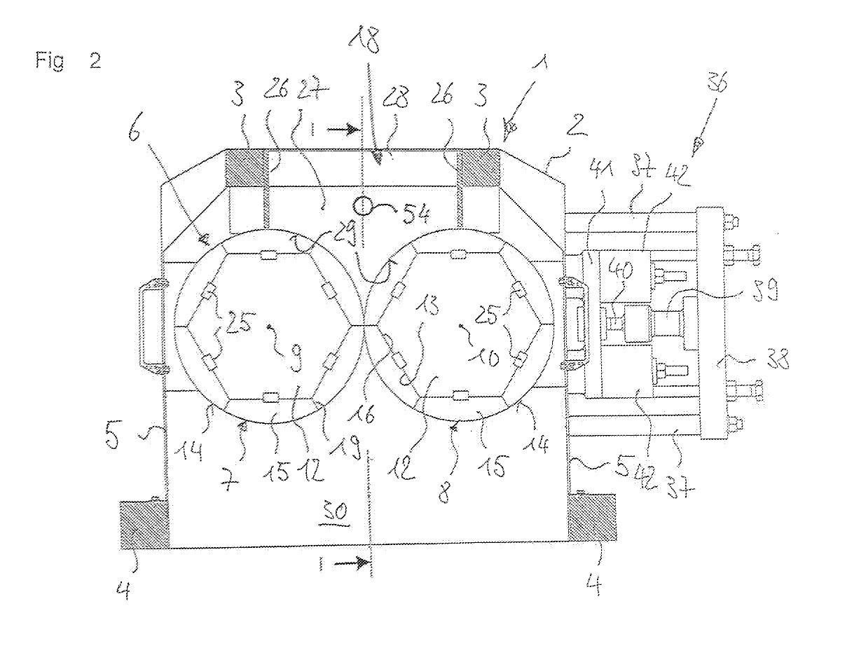

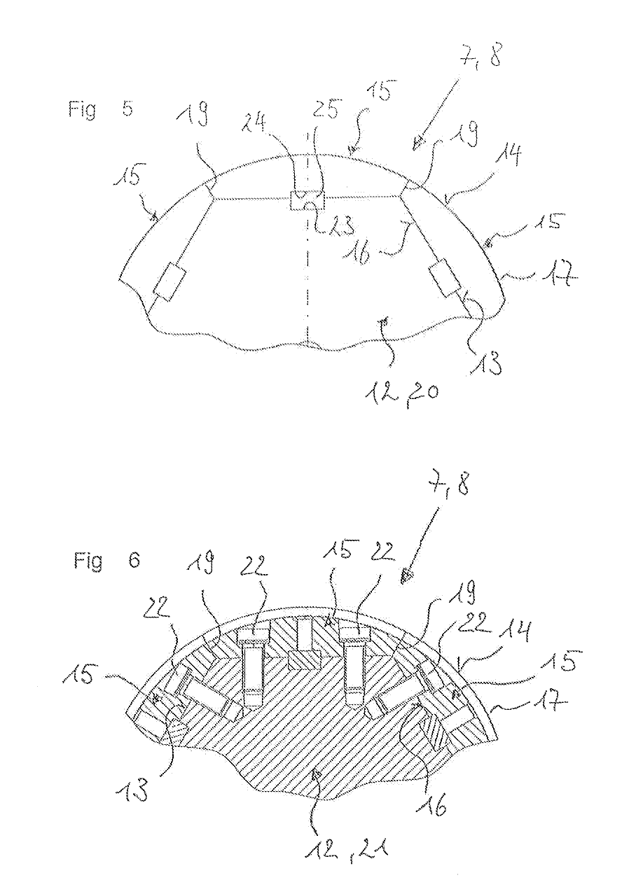

The more detailed design of the rollers 7 and 8 is shown, in particular, in FIGS. 2 and 3 and FIGS. 5 and 6. As shown therein, the rollers 7, 8 each have a solid roller main body 12, the cross section of which corresponds to an equilateral hexagon, wherein each side of the hexagon forms a bearing surface 13, which extends flat in the axial direction.

The shell surface 14 of the rollers 7 and 8, which is used to process the material, is formed by a number of segments 15, which are mounted on the roller main body 12 next to one another in an axially parallel arrangement. Each segment 15 lies, by means of the underside 16 thereof, on one bearing surface 13 of the roller main body 12. The upper side 17 of a segment 15 can be provided with profiling. Adjacent segments 15 form vertical joints in the circumferential direction by means of the axially extending longitudinal edges thereof, thereby resulting in a shell surface 14 which is closed around the periphery and along the length of a roller 7, 8.

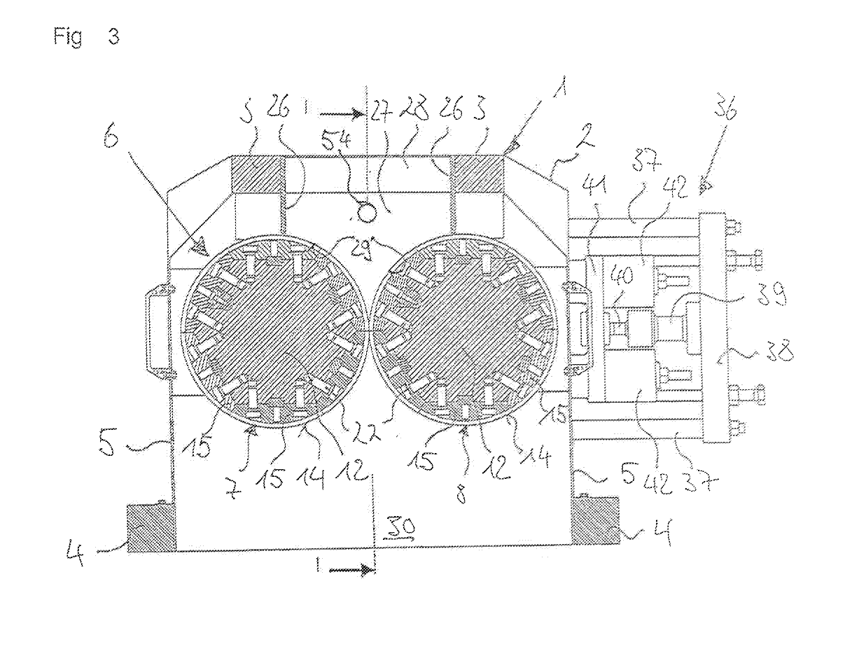

In the axial direction, the rollers 7, 8 are subdivided into a center section 20, which forms the effective shell surface 14 and is provided with profiling, and two short end sections 21, which are used to fasten the segments 15 on the roller ends. FIG. 3 shows a cross-section in the region of the end sections 21. As shown therein, each segment 15 is clamped onto the bearing surface 13 of the roller main body 12 only in the region of the end sections 21 by means of screws 22, which are disposed in pairs. The screw heads are disposed so as to be sunk in stepped bores in the segment 15.

An alternative embodiment comprises a clamping ring, which is produced with undersizing relative to the circumference of the end section 21 and is pressed axially onto the end section 21. The width of the clamping ring corresponds, at most, to the axial length of the respective end section 21. Optionally, the clamping can comprise a circumferential plate flange, which acts as a stop when pressed on and limits the press-on depth.

In order to establish a force-transmitting form-fit connection in the contact joint between the segments 15 and the roller main body 12, an interlocking device are disposed in the bearing surfaces 13 and on the undersides 16 of the segments 15. In the present embodiment, the interlocking device comprise an axially extending fitting groove 23 in the bearing surface 13 and a fitting groove 24, which overlaps same, in the underside 16 of the segments 15. A fitting strip 25 is inserted, in a form-fit manner, into the channel-shaped hollow space formed in the fitting grooves 23 and 24, which is used to center the segments 15 on the bearing surface 13 and functions as force-transmitting toothing between the segments 15 and the roller main body 12.

The region of the device located upstream of the rolling mill 6 is used to feed the input material to the rollers 7 and 8 and is formed by a feed chute 18. The feed chute 18 is limited by two vertical, plane parallel, longitudinal chute walls 26, which are disposed opposite one another in the transverse direction and are each fastened at the upper edge thereof along an upper longitudinal beam 3. At the lower edge thereof, the longitudinal chute walls 26 terminate approximately in the upper apex of the rollers 7 and 8, thereby ensuring a high fill level of the feed chute 18 without the input material being ejected by the rotating rollers 7, 8.

In the longitudinal direction, the feed chute 18 is limited on both sides by an end chute wall 27, which also extends vertically and each of which is fastened at the upper edge thereof on a transverse profile 28, which connects the upper longitudinal beams 3 and extends on the inner side of the transverse walls 2. This results in axial separation between the end chute walls 27 and the transverse walls 2, which corresponds to the cross-sectional dimension of the transverse profile 28 in each case. The end chute walls 27 are therefore offset axially inwardly relative to the transverse walls 2 and thereby form an open space 49, which remains free of input material during material processing. Preferably, the axial width of the open space 49 is at least 2 cm, most preferably at least 3 cm or 5 cm, in order to achieve a sufficient thermal separation of the end chute walls 27 from the transverse walls 2, an uninterrupted material outflow, and a device that is as compact as possible. Cooling air can be introduced into the open space 49, as needed, through an opening 54 disposed in each of the transverse walls 2.

Furthermore, the position of the end chute walls 27 relative to the rollers 7 and 8 is such that the end chute walls 27 are each located in the vertical plane between the center region 20 and the end sections 21 of the rollers 7, 8. The fastening component for the segments 15 located in the region of the end sections 21 are thereby protected against the damaging effects of the input material during the material processing.

Since the rollers 7, 8 are longer than the axial separation between the opposing end chute walls 27, the lower edges 29 of the two end walls 27 bluntly adjoin the shell surface 14 of the rollers 7, 8 so as to maintain a sealing gap, wherein each end wall thereby follows the contour of the corresponding roller peripheral sections from the roller gap to the longitudinal chute walls 26. As a result, each edge 20 has two edge sections which are circular and concave. The end chute walls 27 and the longitudinal chute walls 26 are connected along the mutually assigned edges in order to form a feed chute which is closed, ensures tight containment of the input material, and is as robust and non-deformable as possible.

After passing through the roller gap, the input material enters the region of the material discharge 30, which is closed by the coverings 5 and the transverse walls 2 and is open toward the bottom, through which the processed product is withdrawn from the device.

The transverse walls 2 are each reinforced on the outer side thereof for the rotatable support of the rollers 7, 8. On each transverse wall 2, the reinforcement primarily comprises a horizontal upper flange 31 and a lower flange 32, which extends parallel to said upper flange and is disposed with vertical separation therefrom, wherein disposed between said flanges are a fixed bearing 33 for supporting the roller 7, and a movable bearing 34 which supports the roller 8 and is displaceable in the direction of the fixed bearing 33. The fixed bearing 33 is therefore rigidly fastened on the outer side of the end faces 2, while the movable bearing 34 can be supported by means of sliding bearings 35 on the upper flange 31 and the lower flange 32 and, therefore, can be displaced in the direction of the fixed bearing 33, and so the roller 7 is the fixed roller and the roller 8 is the loose roller.

Both the fixed bearing 33 as well as the movable bearing 34 are configured as roller bearings, in which the rollers 7, 6 are rotatably mounted by means of the shaft stubs 11 thereof. One of the two shaft stubs 11 of each roller 7, 8 is longer and is coupled to a non-illustrated rotary drive for the purpose of rotating the rollers 7 and 8.

A clamping device 36 is provided in the lateral region of each transverse wall 2 for the purpose of positioning the loose roller 8 relative to the fixed roller 7. The clamping device 36 comprises a support frame having an upper and a lower supporting rod 37, which are disposed in the extension of the upper flange 31 and the lower flange 32. The ends of the supporting rods 37 facing away from the flanges 31, 32 are fixedly interconnected by means of a yoke bracket 38. A cylinder piston unit 39 is disposed centrally on the inner side of the yoke bracket 38 and axially parallel between the supporting rods 37, which said cylinder piston unit bears, with the rigid part thereof, centrally against the inner side of the yoke bracket 38. The movable piston 40 of the cylinder piston unit 39 abuts a transversely extending web 41, which, by means of the ends thereof, supports two spring elements 42, which are parallel to the supporting rods 37 and are preloaded in the direction of the movable bearing 34, wherein said spring elements bear against the movable bearing 34 and press said movable bearing in the direction of the fixed bearing 33. The clamping device 36 can be used to adjust the roller gap by horizontally displacing the movable bearing 34.

The spring elements 42 substantially comprise two hollow cylindrical parts, which are slid axially into one another. One preloaded spring in the interior of the two hollow cylindrical parts bears, by means of the ends thereof, against the two parts and thereby elastically clamps the movable part in the direction of the movable bearing 34. The spring elements 42 thereby function as a protective device in the event that the input material contains foreign objects that are too large to pass through the roller gap. If a spreading force is generated by the foreign object, the spring elements 42 allow the loose roller 8 to deflect laterally against the preload force, the roller gap briefly widens and the foreign object is discharged from the comminution zone.

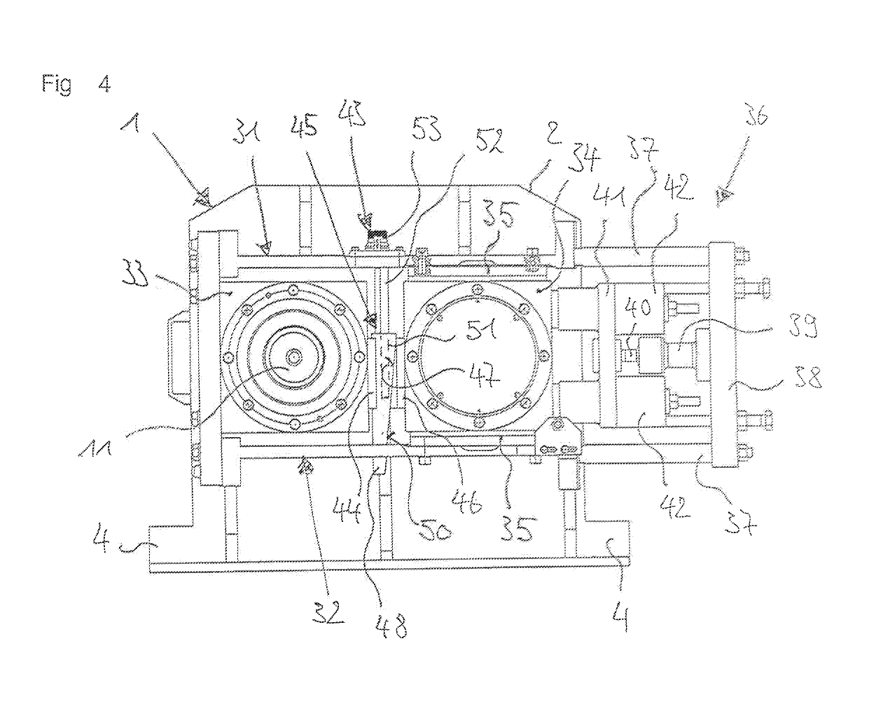

The roller gap is set by means of the clamping device 36 in interaction with adjustable stop device 45, the design of which is shown primarily in FIG. 4. The stop device 45 comprise a first wedge element 48 having a first wedge surface 50 and a second wedge element 46 having a second wedge surface 47. The first wedge element 48 and the second wedge element 46 bear against one another by means of the opposing wedge surfaces 50 and 47 thereof and form a slanted sliding surface. The sides of the wedge elements 48 and 46 facing away from the wedge surfaces 50 and 47 bear against the fixed bearing 33 and the movable bearing 34, respectively, wherein the second wedge element 46 is rigidly connected to the movable bearing 34. The first wedge element 48, however, is displaceably mounted on the fixed bearing 33, and therefore a sliding bearing 44 having lateral guide surfaces is disposed on the fixed bearing 33. In this manner, the first wedge element 46 can be moved within the linear guide formed by the sliding bearing 44 and can be moved along the sliding surface formed by the wedge surfaces 50, 47, relative to the second wedge element 46. In association therewith, the roller 8 moves in the direction predetermined by the movable bearing 34.

The movement of the first wedge element 48 relative to the second wedge element 46 is brought about by means of an advancing unit 43, which substantially comprises a threaded spindle 52, the upper end of which is rotatably anchored in a pivot bearing 53 on the upper flange 31, and the opposing, lower end of which engages into a threaded bore 51 in the first wedge element 48. The threaded spindle 52 can be driven manually or by means of a motor and, by screwing the first wedge element 40 in or out, causes the first wedge element 40 to move relative to the second wedge element 46, thereby changing the spacing between the fixed roller 7 and the loose roller 8.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for processing free-flowing input material for comminution, compaction, and briquetting of input material, the device comprising:
a machine frame formed by longitudinal and transverse walls;
a rolling mill having at least one pair of oppositely rotating rollers arranged in the machine frame, the rotating rollers being arranged axially parallel next to one another so as to maintain a radial roller gap and are rotatably mounted in the transverse walls, wherein the input material is processed upon passage through the roller gap, wherein an upstream region located upstream of the roller gap is used to feed the input material and a downstream region is used to discharge the material; and
a feed chute arranged in the upstream region for feeding, the feed chute having longitudinal chute walls and end chute walls, the end chute walls each disposed with an axial separation between the transverse walls of the machine frame to form an open space.

2. The device according to claim 1, wherein an axial separation of the opposing end chute walls is smaller than an axial length of the rollers, and wherein edges of the end chute walls facing the rollers each abut a shell surface of the rollers in a radial direction.

3. The device according to claim 1, wherein an axial separation between the end chute walls approximately corresponds to that of an axial length of the rollers, and wherein edges of the end chute walls facing the rollers radially overlap with end faces of the rollers and therefore abut the rollers in the axial direction.

4. The device according to claim 1, wherein the rollers are subdivided, in an axial direction, into a center section, which forms a shell surface used for material processing, wherein two end sections are used to fasten shell segments, and wherein the end sections are each located in a region between a transverse wall and an end wall.

5. The device according to claim 1, wherein an inner axial separation is at least 2 cm, at least 3 cm, or at least 5 cm.

6. The device according to claim 1, wherein the open space within the housing leads directly into the material discharge in a radial direction.

7. The device according to claim 1, wherein the open space is closed on sides and toward a top.

8. The device according to claim 1, wherein air passes through the open space from a top to a bottom.

9. The device according to claim 1, wherein the longitudinal chute walls each abut the rollers in a region of a roller apex, via edges thereof facing the rollers.

10. The device according to claim 1, wherein the longitudinal chute walls and end chute walls are connected at mutually assigned edges thereof.

11. The device according to claim 1, wherein bearings for the rollers are disposed at the transverse walls.
